(19) United States
(12) Patent Application Publication
(10) Pub. No.: US 2005/0096864 A1
(43) Pub. Date: May 5, 2005

(54) Method and system for managing a testing task

(76) Inventor: Carlos Alberto Bonilla, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/699,532

(22) Filed: Oct. 31, 2003

(51) Int. Cl. G01L 15/00

(52) U.S. Cl. 702/121

(57) ABSTRACT

A method and system for managing a testing task are disclosed. A plurality of test cases to run is received. Each test case includes a plurality of requirements for running the respective test case. An identification of a group of available test systems on which to run the test cases is received. For each test case, a list of applicable test systems from the group that satisfy the requirements of the respective test case is determined. Test cases are automatically selected and started to run based on each respective list and the available test systems so that as many test cases as possible are run in parallel. When any test case finishes running and releases a test system to the group of available test systems, an additional test case is automatically selected and started to run if possible based on the respective list and the available test systems.

### BACKGROUND OF THE INVENTION

1. Field of the Invention

The present invention generally relates to running tests on systems. More particularly, the present invention relates to the field of managing a testing task.

2. Related Art

A testing task may involve running many different test cases. These test cases are run on available test systems. Usually, there are more test cases than available test systems. Typically, each test case has a set of requirements. Number and type of test systems (e.g., server, workstation, personal computer, etc.) on which to run the test case and specific attributes (e.g., operating system, RAM size, mass storage size, etc.) that must be possessed by the test systems are examples of requirements of a test case.

Typically, the testing task is characterized by its wide use of manual processes. Before the testing task is begun, specific test systems have to be allocated to or matched with specific test cases based on the requirements of the test case. That is, a hard coding process is used or a virtual mapping process is used. Thus, the test systems and the test cases that can run in parallel on the test systems must be known before the testing task is started. Since there are more test cases than test systems, several test cases have to be run in a serial manner on the test systems.

If a test system becomes inoperable, the testing task is interrupted because test cases that were hard coded to run on the inoperable test system cannot be run. Moreover, if a test case fails while running, state/configuration information of the failure on the test system on which the failed test case occurred can be lost since other test cases have to be run on the same test system. Hence, the current techniques for running a testing task are inefficient and labor intensive.

### SUMMARY OF THE INVENTION

A method and system for managing a testing task are disclosed. A plurality of test cases to run is received. Each test case includes a plurality of requirements for running the respective test case. An identification of a group of available test systems on which to run the test cases is received. For each test case, a list of applicable test systems from the group that satisfy the requirements of the respective test case is determined. Test cases are automatically selected and started to run based on each respective list and the available test systems so that as many test cases as possible are run in parallel. When any test case finishes running and releases a test system to the group of available test systems, an additional test case is automatically selected and started to run if possible based on the respective list and the available test systems.

### BRIEF DESCRIPTION OF THE DRAWINGS

The accompanying drawings, which are incorporated in and form a part of this specification, illustrate embodiments of the invention and, together with the description, serve to explain the principles of the present invention.

FIG. 1 illustrates a system in accordance with an embodiment of the present invention.

FIG. 2 illustrates a flow chart showing a method of managing a testing task in accordance with an embodiment of the present invention.

FIGS. 3 and 4A-4E illustrate management of a testing task in accordance with an embodiment of the present invention.

### DETAILED DESCRIPTION OF THE INVENTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention.

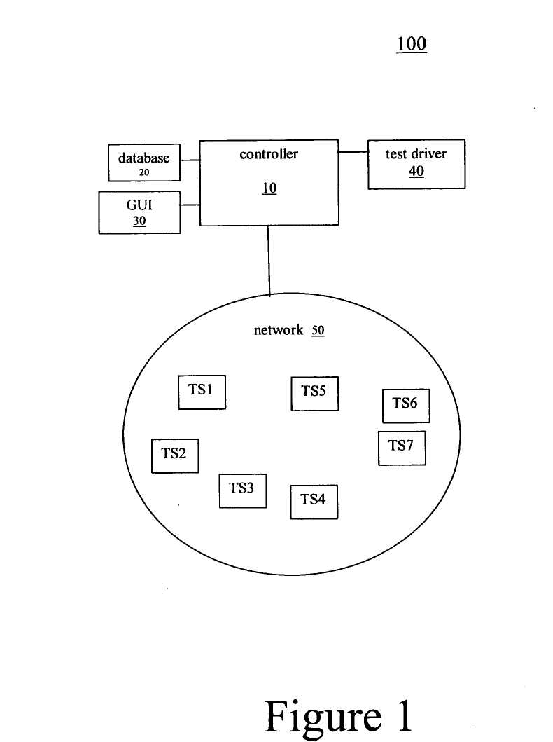

FIG. 1 illustrates a system 100 in accordance with an embodiment of the present invention. The system 100 includes a controller 10, a database 20, a graphical user interface (GUI) 30, a test driver 40, and a network 50 of test systems TS1-TS7. It should be understood that the system 100 can have other configurations.

In particular, the test driver 40 enables the management of a testing task. The testing task can include any number of test cases to be run on the test systems TS1-TS7. There is no need for the user to specify which test cases can run in parallel when the test cases of the testing task are defined. This is determined when the testing task is begun based on the available test systems TS1-TS7 provided to the test driver 40. Moreover, there is no need to define a specific mapping of virtual host test system names to real host test system names.

Furthermore, a user can utilize the GUI 30 to define the test cases and their set of requirements. The match of the test system to these requirements is determined automatically by the test driver 40 when it executes the testing task. The database 20 can store attribute information of the test systems TS1-TS7. The test driver 40 utilizes the controller 10 to facilitate management of the testing task, whereas the controller 10 can control the network 50 of test systems TS1-TS7. Moreover, the test driver 40 reduces test case maintenance and allows for varied amounts of automatic parallel test case execution when test systems become available for running test cases. Test driver 40 selects and starts test cases to run so that as many test cases as possible are run in parallel based on the available test systems and the requirements of the test cases. Additionally, the test driver 40 can be implemented in hardware, software, or a combination thereof.

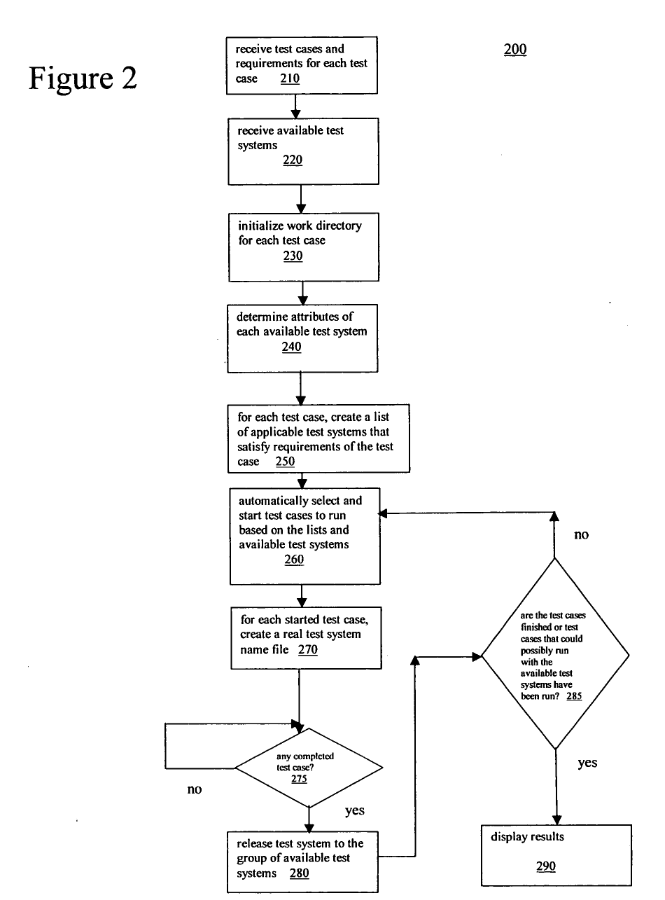

FIG. 2 illustrates a flow chart showing a method 200 of managing a testing task in accordance with an embodiment of the present invention. Reference is made to FIG. 1. In an embodiment, the present invention is implemented as computer-executable instructions for performing this method 200. The computer-executable instructions can be stored in any type of computer-readable medium, such as a magnetic disk, CD-ROM, an optical medium, a floppy disk, a flexible disk, a hard disk, a magnetic tape, a RAM, a ROM, a PROM, an EPROM, a flash-EPROM, or any other medium from which a computer can read.

At Step 210, the test driver 40 receives the test cases that are defined by the user. Each test case includes a plurality of requirements for running the test case. Number and type of test systems (e.g., server, workstation, personal computer, etc.) on which to run the test case and specific attributes (e.g., operating system, RAM size, mass storage size, etc.) that must be possessed by the test systems are examples of requirements for a test case.

Moreover, At Step 220, the test driver 40 receives an identification of a group of available test system (e.g., TS1-TS7) on which to run the test cases. At Step 230, the test driver 40 initializes a work directory (or set of files) for each test case. Hence, the status of the test case can be tracked and the result of running the test case can be stored.

At Step 240, the test driver 40 determines the relevant attributes (e.g., operating system, RAM size, mass storage size, etc.) of each available test system (e.g., TS1-TS7). The relevant attributes may be retrieved from the database 20. Alternatively, the test driver 40 may query each available test system. Moreover, at Step 250, for each test case, the test driver 40 creates a list of applicable test systems that satisfy the requirements of the test case.

Furthermore, at Step 260, the test driver 40 automatically selects and starts test cases based on the lists and the available test systems so that as many test cases as possible are run in parallel. At Step 270, for each started test case, the test driver 40 creates a real test system name file automatically, unlike the manual hard coding process of prior techniques for running testing tasks.

At Step 275 the test driver 40 determines whether a test case has completed running. If a test case has completed running, the method proceeds to Step 280. Otherwise, the test driver 40 waits a period of time and checks again at Step 275 if any test case has completed running.

At Step 280, when any test case finishes running, the test systems of the test case are released to the group of available test systems so that the test driver 40 can select and start additional test cases if possible based on the lists and the available test systems.

At Step 285, the test driver 40 determines if the test cases have finished running or if test cases that could possibly run with the available test systems have been run. If the test driver 40 determines that the test cases have finished running or that test cases that could possibly run with the available test systems have been run, the method 200 proceeds to Step 290 to display the results of the testing task. Otherwise, the method 200 proceeds to Step 260.

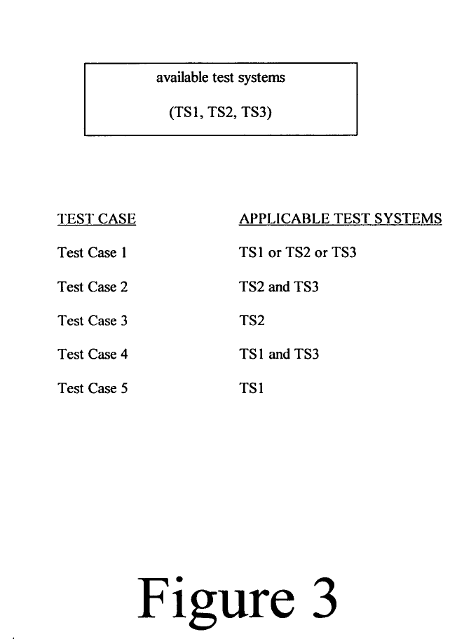

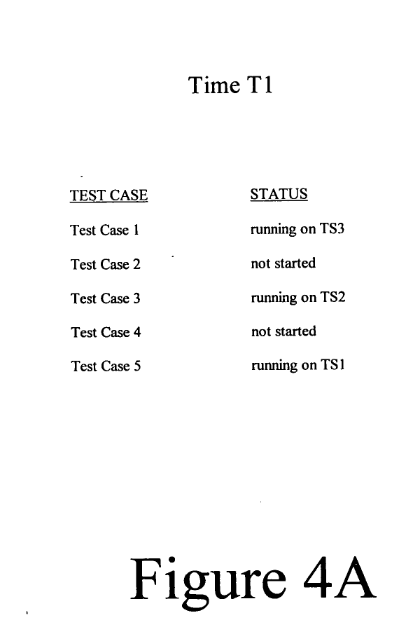

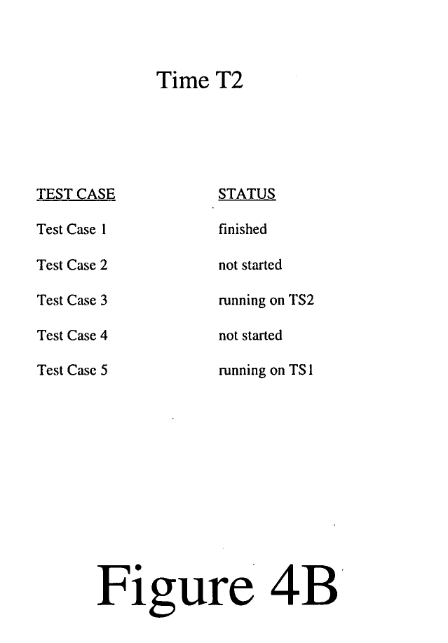

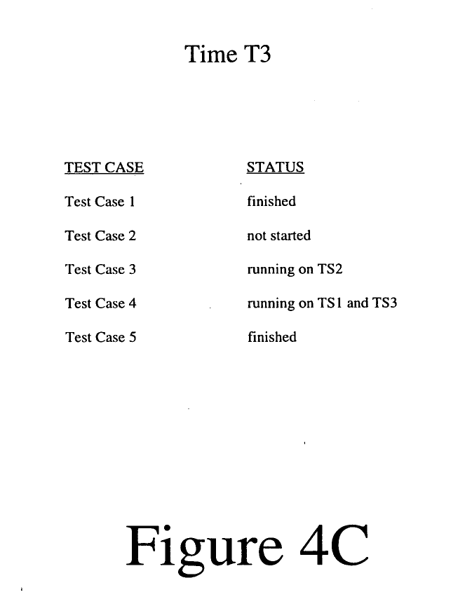

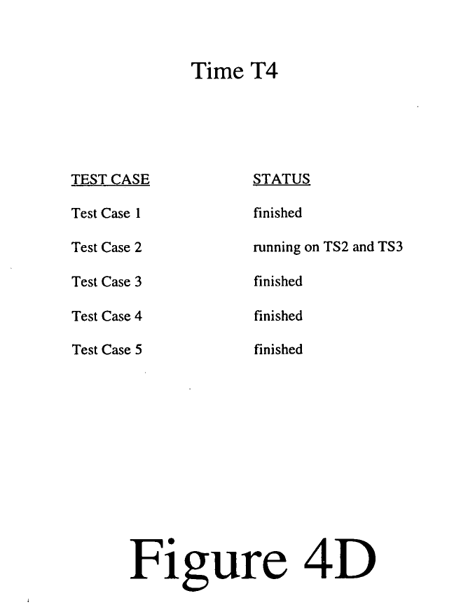

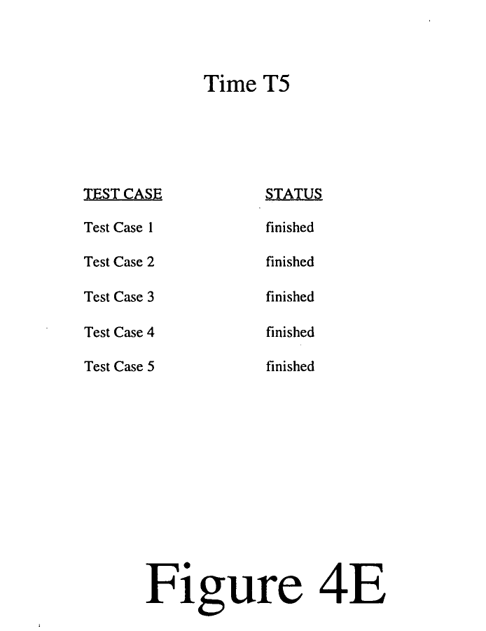

FIGS. 3 and 4A-4E illustrate management of a testing task in accordance with an embodiment of the present invention. FIG. 3 depicts the available test system TS1, TS2, and TS3. Moreover, FIG. 3 shows that the test driver 40 has received Test Case 1 to Test Case 5 from the user. Additionally, the test driver 40 has automatically created the list of applicable test systems for each test case by matching the available test systems with the requirements of the test cases. For example, Test Case 1 can be run on TS1 or TS2 or TS3. However, Test Case 2 has to run on TS2 and TS3.

In FIG. 4A, at time T1 the test driver 40 has selected and started Test Case 1, Test Case 3, and Test Case 5 to run in parallel. Moreover, in FIG. 4B at time T2, Test Case 1 has finished running but Test Case 2 and Test Case 4 have not been started by the test driver 40 because currently the available test systems do not match the applicable test systems of Test Case 2 and Test Case 4.

FIG. 4C depicts, at time T3, Test Case 5 has finished running and that the test driver 40 has started running Test Case 4. Moreover, in FIG. 4D at time T4, Test Case 4 and Test Case 3 have finished running. Additionally, Test Case 2 has been started by the test driver 40. Finally, FIG. 4E shows that at time T5 all the test cases have been completed.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method of managing a testing task, said method comprising:
receiving a plurality of test cases to run, each test case including a plurality of requirements for running said respective test case;
receiving an identification of a group of available test systems on which to run said test cases;
for each test case, determining a list of applicable test systems from said group that satisfy said requirements of said respective test case;
automatically selecting and starting test cases to run based on each respective list and said available test systems so that as many test cases as possible are run in parallel; and
when any test case finishes running and releases a test system to said group of available test systems, automatically selecting and starting an additional test case to run if possible based on said respective list and said available test systems.

2. The method as recited in claim 1 wherein said receiving said identification of said group of available test systems includes:
for each available test system, determining a plurality of attributes of said respective available test system.

3. The method as recited in claim 1 further comprising:
keeping track of a status of each test case.

4. The method as recited in claim 1 further comprising:
completing said testing task when test cases that could have run on said available test systems have finished running.

5. The method as recited in claim 4 further comprising:
displaying results of said test cases.

6. The method as recited in claim 1 wherein said automatically selecting and starting test cases to run includes:
for each test case, creating a real test system name file.

7. The method as recited in claim 1 further comprising:
initializing a work directory for each test case.

8. A computer-readable medium comprising computer-readable instructions stored therein for performing a method of managing a testing task, said method comprising:
receiving a plurality of test cases to run, each test case including a plurality of requirements for running said respective test case;
receiving an identification of a group of available test systems on which to run said test cases;
for each test case, determining a list of applicable test systems from said group that satisfy said requirements of said respective test case;
automatically selecting and starting test cases to run based on each respective list and said available test systems so that as many test cases as possible are run in parallel; and
when any test case finishes running and releases a test system to said group of available test systems, automatically selecting and starting an additional test case to run if possible based on said respective list and said available test systems.

9. The computer-readable medium as recited in claim 8 wherein said receiving said identification of said group of available test systems includes:
for each available test system, determining a plurality of attributes of said respective available test system.

10. The computer-readable medium as recited in claim 8 wherein said method further comprises:
keeping track of a status of each test case.

11. The computer-readable medium as recited in claim 8 wherein said method further comprises:
completing said testing task when test cases that could have run on said available test systems have finished running.

12. The computer-readable medium as recited in claim 11 wherein said method further comprises:
displaying results of said test cases.

13. The computer-readable medium as recited in claim 8 wherein said automatically selecting and starting test cases to run includes:
for each test case, creating a real test system name file.

14. The computer-readable medium as recited in claim 8 wherein said method further comprises:
initializing a work directory for each test case.

15. A system comprising:
a plurality of available test systems;
a controller for controlling said available test systems; and
a test driver for receiving a plurality of test cases, each test case including a plurality of requirements for running said respective test case, wherein said test driver matches said available test systems with said test cases based on said requirements, and wherein said test driver selects and starts test cases to run so that as many test cases as possible are run in parallel based on said available test systems and said requirements.

16. The system as recited in claim 15 wherein when any test case finishes running and releases a test system to said group of available test systems, said test driver selects and starts an additional test case to run if possible based on said respective requirements and said available test systems.

17. The system as recited in claim 15 wherein said test driver determines a plurality of attributes of each available test system.

18. The system as recited in claim 15 wherein said test driver keeps track of a status of each test case.

19. The system as recited in claim 15 wherein said test driver finishes executing when test cases that could have run on said available test systems have finished running.

20. The system as recited in claim 19 wherein said test driver displays results of said test cases.

21. The system as recited in claim 15 wherein said test driver creates a real test system name file for each test case.

22. The system as recited in claim 15 wherein said test driver initializes a work directory for each test case.
